(19) United States
(12) Patent Application Publication
(10) Pub. No.: US 2012/0262916 A1
(43) Pub. Date: Oct. 18, 2012

(54) Lighting Device Provided with a Light Radiation Propagation Optical Component

(75) Inventors: Walter Gadda, Concorezzo (IT); Lucio Lecchini, Concorezzo (IT)

(73) Assignee: ALDABRA S.R.L., Concorezzo, Milano (IT)

(21) Appl. No.: 13/202,155

(22) PCT Filed: Feb. 18, 2010
(86) PCT No.: PCT/IT2010/000058

§ 371 Date: Feb. 20, 2012

(30) Foreign Application Priority Data
Feb. 20, 2009 (IT) MI2009A000232

(51) Int. Cl. F21V 11/00; E04F 19/02; B32B 37/14; F21V 31/04

(52) U.S. Cl. 362/235; 52/28; 156/60

(57) ABSTRACT

There is described a lighting device (100) comprising: means for generating a plurality of beams of light radiation (1, s1-sn); an optical component (4) facing said generating means to allow propagation of light radiation; a housing (2) for the generating means and for the optical component equipped with an opening (8) for the emission of light radiation. The optical component (4) is rigid and is such as to substantially fill a region interposed between the generating means and the emission opening.

### BACKGROUND OF THE INVENTION

The present invention relates to the sector of lighting devices such as, by way of non-limiting example, lights with LED sources.

### PRIOR ART

Lights provided with a plurality of LED (Light Emitting Diode) sources produced in an electronic circuit board on which a control circuit of these sources is also printed, are known. Some of these lights are destined to be installed outdoors and built into masonry structures such as pavements, walls and roads.

In particular, according to prior art, lights used are provided with a container comprising a base to support the electronic circuit board and a sheet of glass or plastic material to close the container; the sheet is spaced from the electronic circuit board and separated therefrom by a region of free space.

The document WO-A-2007-013121 describes a lighting device for built-in installation equipped with LED sources arranged on an electronic control device embedded in an insulating resin.

### SUMMARY OF THE INVENTION

The Applicant has noticed that some of the prior art lights mentioned above do not have satisfactory performance in relation to their drive-over and waterproof properties or have fabrication difficulties that do not ensure satisfactory performance from the viewpoint of orientation and alignment of the light sources inside the supporting structure. Moreover, due to inadequate protection against infiltration of impurities or moisture, they are subject to phenomena of oxidation which cause a considerably shorter useful life compared to the particularly long useful life of LED devices.

The aim of the present invention is to propose a lighting device with improved performances in terms of drive-over and/or waterproof properties. It is particularly desirable to provide a lighting device that can be built into masonry structures, such as roads for motor vehicles, or also used in water, such as in tanks or swimming pools, maintaining an acceptable useful life of the product.

The object of the present invention is achieved by a lighting device as defined in the appended claim 1 and by preferred embodiments thereof described in claims 2 to 15. The present invention also relates to a masonry structure comprising a lighting device as defined in the appended claim 16 and a fabrication method defined in claim 17.

### BRIEF DESCRIPTION OF THE DRAWINGS

The present invention is described in detail below by way of non-limiting example, with reference to the accompanying drawings, wherein:

FIG. 1 shows an exploded perspective view of the lighting device according to one embodiment of the invention;

FIG. 2 shows a section of a housing of said lighting device;

FIG. 3 shows some steps for the assembly of said lighting device;

FIG. 4 shows a side view of an optical component that can be used by said lighting device.

### DETAILED DESCRIPTION

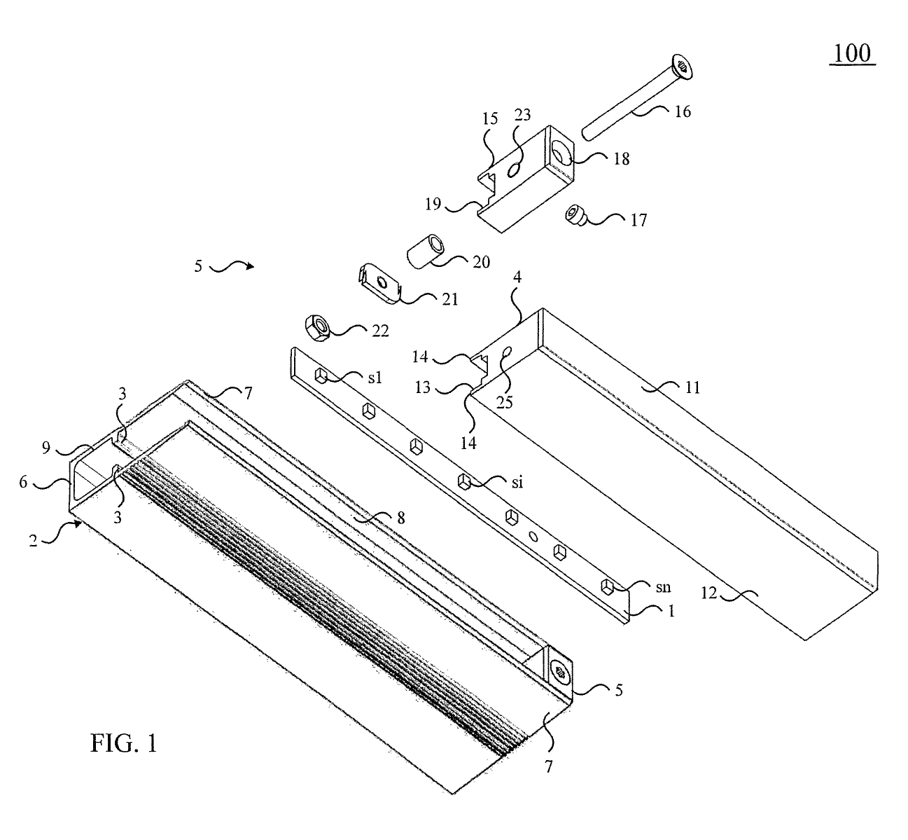

FIG. 1 shows a lighting device 100 in a disassembled configuration, produced according to a particular embodiment of the invention. The lighting device 100 comprises an electronic circuit board 1 bearing a plurality of light radiation sources s1-sn and an optical component 4 for propagation and mixing of the light beams produced by the sources s1-sn. Moreover, the lighting device 100 comprises a housing 2 for the electronic circuit board 1 and for the optical component 4 and a fixing kit or assembly for the optical component 4 comprising, in the example, two fixing units 5.

Preferably, the light radiation sources s1-sn are LED (Light Emitting Diode) devices, of the type available on the market, controlled by means of a suitable printed circuit produced on the electronic circuit board 1 (not shown). The electronic circuit board 1 shown in FIG. 1 is of the plate type (i.e. rectangular) and the LEDs s1-sn are aligned along the longitudinal direction of the board. Moreover, the LEDs s1-sn are arranged on a same face of the electronic circuit board 1 so as to emit light radiation in beams substantially the same as one another and in a direction of the optical component 4.

According to one example of embodiment, the LEDs s1-sn are arranged with a pitch of between 5 mm and 50 mm, preferably 20 mm and 35 mm and according to a particular example the pitch is equivalent to 25 mm. Again according to a specific example the devices can be arranged on the electronic circuit board 1 with a linear density equivalent to 50 LED devices per metre.

The plurality of LEDs s1-sn, and the methods of controlling these LEDs, can be selected according to specific needs, so as to generate radiation at the desired frequencies and tones. With reference to the tones of light expressed in temperature of the colour in ° K, according to particular examples the LEDs s1-sn can generate monochromatic light radiation at 3000° K (cold white), monochromatic radiation at 5500° K (yellowish white) or a radiation with RGB (Red Green Blue) signal which allows various colours to be obtained. According to a specific embodiment, the LEDs s1-sn are suitable to emit a light beam with a lobe having an aperture of around 120°.

Advantageously, the electronic circuit board 1 is encapsulated in an insulating and protective material (not shown in FIG. 1) such as an epoxy resin (for example, with a thickness of a few millimetres) which ensures it is waterproof and protected from impurities. The encapsulating epoxy resin is suitable for the operating temperatures of the LEDs. For example, a two-component resin can be used comprising the epoxy resin as first component and a second component such as a catalyst, which allows the resin to pass from liquid (or fluid) state to solid state.

Alternatively to the electronic circuit board 1 provided with the LED devices s1-sn, other means can be used for generating light radiation, such as other types of photodiodes, preferably mounted with SMD (Surface Mount Technology) technology or incandescent or gas discharge lamps.

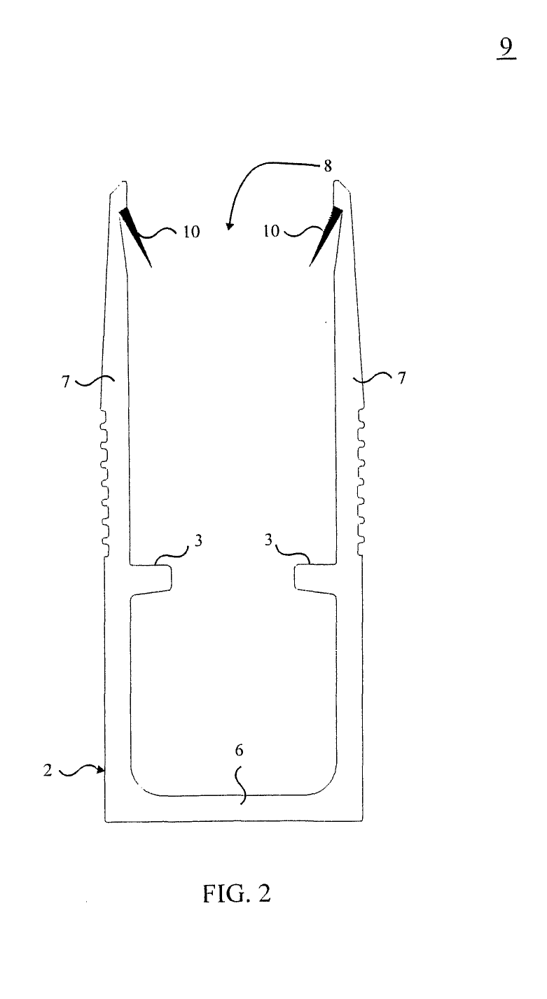

With reference to the housing 2 (a section of which is also visible in FIG. 2), this is preferably a formwork, provided with a bottom wall 6 (elongated in shape) and two facing lateral walls 7, joined to the bottom wall 6 and substantially perpendicular thereto.

The formwork 2 identifies a hollow inner region equipped with means to support the electronic circuit board 1 and the optical component 4 which are preferably suitably joined by resin coating. According to the example shown, these support means are composed of two tabs or inner edges 3, each joined to a respective lateral wall 7, which form the base of the optical component 4.

The two tabs 3 separate the inner cavity into an upper region adapted to house the optical component 4, provided with an opening 8 for light radiation, and a lower region 9 adapted to house appropriate wires for power supply and control of the electronic circuit board 1.

The formwork 2 can be made of metal material, such as aluminium, or can preferably be made of plastic material, advantageously such as polycarbonate. The formwork 2 can be obtained by extrusion, for example, of polycarbonate and can be opaque to the radiation to be emitted.

According to a particularly preferred embodiment, the lateral walls 7 of the formwork 2 are equipped, in proximity of the free ends thereof, with a relative inner seal 10 which runs in longitudinal direction. This seal 10 has, for example, a triangular section and is inclined with respect to the respective wall 7 to which it is fixed. The seals 10 give stability to the optical component 4 inserted into the formwork and obstruct the entry of impurities. Advantageously, the seals 10 (for example transparent) are made of polyurethane and can be obtained through coextrusion with the polycarbonate of which the formwork 2 is composed.

Reference shall now be made to the optical component 4, which is a rigid body adapted to propagate light radiation and which preferably comprises a mixing layer 11 and a propagating layer 12 of the beams of light radiation. The propagating layer 12 is such as to substantially fill a region interposed between the electronic circuit board 1 (resin coated) and the mixing layer 11 and allows light radiation to propagate towards the mixing layer 11.

The propagating layer 12 is substantially transparent to light radiation while the mixing layer 11 is partially opaque and is such as to cause a diffusion and consequent mixing of the light beams emitted by the LEDs s1-sn. Mixing of the beams means that an observer perceives the light delivered from the device 100 as homogeneous (i.e. as if it were generated by a single source) and cannot distinguish the various light points associated with the LEDs s1-sn.

According to the example shown, the optical component 4 has a substantially parallelepiped shape, and the lower part thereof is provided with a groove 13 destined to house the electronic circuit board 1. However, the optical component 4 and the formwork 2 can have other shapes, for example a trapezoidal or round section.

The propagating layer 12 is provided with lower edges 14 shaped so as to be able to rest on the electronic circuit board 1 or, preferably, on the two tabs 3 of the formwork 2. In accordance with what is shown in FIG. 1, the mixing layer 11 has a thickness less than that of the propagating layer 12. For example, the mixing layer 11 has a thickness of 2 mm, while the propagating layer 12 has a thickness of 28 mm.

The propagating layer 12 gives the lighting device 100 an increased mechanical strength with respect to that obtainable only with the formwork 2 and as it substantially fills the formwork 2 it protects the electronic circuit board 1 from infiltration of water or gas or of other impurities.

The propagating layer 12 can be made of a material comprising thermoplastic polymer material. Preferably, this thermoplastic polymer material is an acrylic resin. Examples of acrylic resins that can be used comprise: poly-butyl-methacrylate, poly-butyl-n-acrylate, poly-ethyl-acrylate, poly-ethyl-methacrylate, poly-methylacrylate, poly-methyl-chloroacrylate or, preferably, poly-methyl-methacrylate PMMA. PMMA is particularly advantageous due to its mechanical strength and waterproof nature. The propagating layer 12 can be obtained, for example, through extrusion of PMMA.

The mixing layer 11 is preferably produced with the same materials mentioned for the propagating layer 12 to which pigments are added to make it partially opaque or in any case suitable to cause internal diffusion of the light beams that produces the required mixing. The mixing layer 11 can be obtained, for example, by extrusion of PMMA.

Advantageously, the optical component 4 is produced in a single piece. Preferably, the optical component 4 is obtained through coextrusion, i.e. simultaneously using a same extrusion die for both the layers of which it is composed. In particular, this extrusion die can be fed—simultaneously—with the material destined to form the propagating layer 12, substantially transparent, and with the same material, also containing pigments, to produce the mixing layer 11.

Alternatively, the optical component 4 can be obtained by moulding or with other suitable techniques. Moreover, the optical component 4 can be produced in a single propagating layer such as the layer 12, without the addition of pigments, so that the light points of the LEDs s1, sn are visible. According to another embodiment, the optical component 4 can be produced in a single propagating layer such as the layer 11, i.e. in a single layer provided with pigments.

According to the example described, the fixing kit comprises two fixing devices 5 each provided with a coupling and closing block 15 and equipped with means for fixing to the formwork and means for engaging with the optical component 4. The coupling and closing block 15 has a parallelepiped shape and is provided in the lower region thereof with a groove 19 having an internal shape analogous to the groove 13 present in the propagating layer 12 of the optical component 4. The groove 13 can be obtained, for example, by milling.

Moreover, the coupling and closing block 15 is provided with a through hole 18 and with a lateral engaging cavity 23. The means for fixing to the formwork 2 comprise, for example, a first pin 16 to be inserted into the through hole 18, a bushing 20, a perforated safety plate 21 and a nut 22. The means for engaging with the optical component include a second pin 17 to be inserted into the lateral engaging cavity 23.

The coupling and closing block 15 can be made with the materials of which the propagating layer 12 is made and, therefore, it is preferably made of PMMA. The first pin 16, the second pin 17 and the perforated plate 21 can be made of steel.

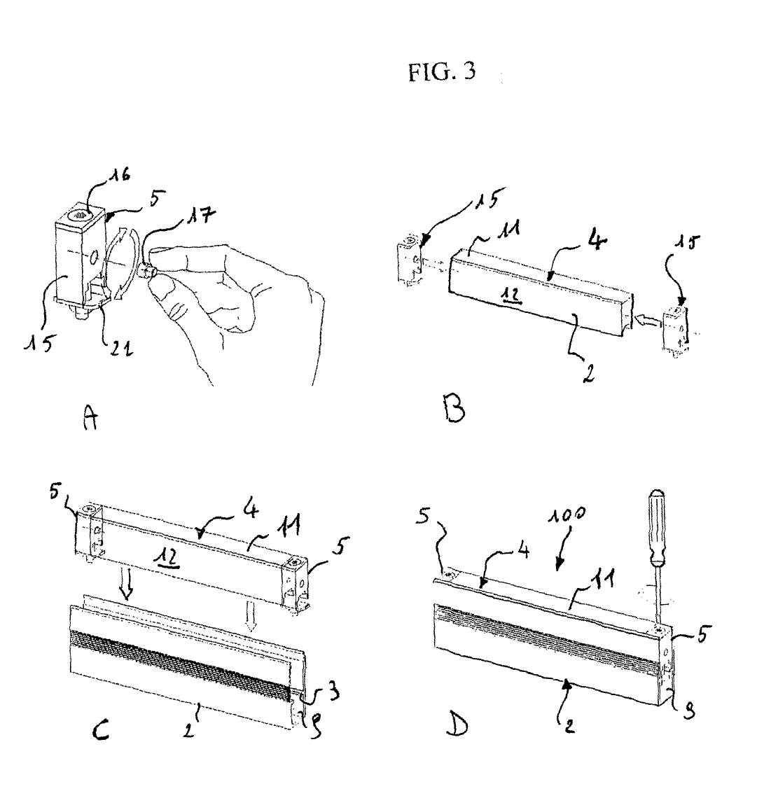

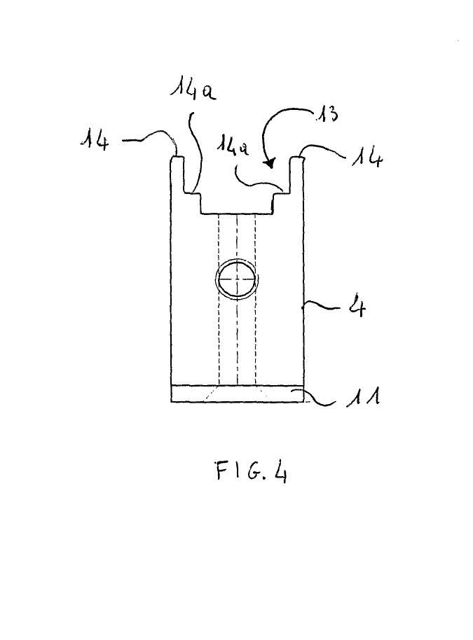

FIG. 3 relates to assembly of the lighting device 100. According to a preferred embodiment of this process, protective and transparent material, such as a silicone resin, is deposited on each single LED s1-sn (i.e. without covering the entire electronic circuit board 1), and this silicone resin is then left to dry. Epoxy resin (already mentioned) is applied in the groove 13 and the electronic circuit board 1 is then placed inside the groove 13 so that it closes the groove. The lateral edges of the face of the electronic circuit board 1 bearing the LEDs s1-sn are placed on the corresponding supporting guides 14a inside the groove 13 (see FIG. 4). A further resin coating step is then performed using the epoxy resin already mentioned, to block the electronic circuit board 1 firmly in the groove 13. The epoxy resin therefore encapsulates the electronic circuit board 1. This method, which uses the optical component 4 equipped with the groove 13, allows precise positioning and alignment of the electronic circuit board 1 to be achieved.

The first pin 16 is inserted in the through hole 18 so as to pass through the bushing 10 placed in the groove 19 and the perforated plate 21. The second pin 17 is inserted with interference fit into the lateral cavity 23 (FIG. 3A). The free ends of the second pins 17 are inserted into specific cavities 25 obtained in the minor lateral walls of the propagating layer 12 of the optical component 4 (FIG. 3B). In this way, the coupling and closing blocks 15 are fixed to the optical component 4.

The structure comprising the coupling and closing blocks 15 and the optical component 4 fixed to the electronic circuit board 1 is inserted in the formwork 2 (FIG. 3C). In particular, the lower edges 14 of the groove 13 rest on the tabs 3 of the formwork 2.

Each first pin 16 is tightened so that the relative perforated plate 21 engages under the supporting tabs 3. Each first pin 16 is tightened and blocked by means of the relative nut 22 (FIG. 3D) so as to ensure fixing to the formwork 2. The perforated plate 21 is preferably equipped with teeth 26 that oppose removal thereof from the groove 13. The wires to be connected to the electronic circuit board 1 can then be arranged in the lower region 9.

It is observed that, advantageously, the dimensions of the formwork 2 and of the optical component 4 are such that the upper surface of the mixing layer 11 is aligned with the upper surface of the end edges of the lateral walls 7 of the formwork 2, being particularly advantageous for building into masonry structures.

During operation, the beams of light radiation generated by the LEDs s1-sn propagate inside the propagating layer 12 being subjected only to slight attenuation given the substantial transparency of this layer. During propagation inside the propagating layer 12 these beams diverge and overlap causing diffusion to take place inside the mixing layer 11, so that a homogeneous radiation is emitted outside the lighting device 100, making it impossible to distinguish the single LED sources s1-sn.

According to the preferred embodiment, the lighting device 100 is a light that can be built into masonry structures such as: pavements, roads, tanks or swimming pools. The use of a rigid propagating layer 12 makes it possible to obtain a light that can be walked over, driven over and is waterproof, even if built into the bottom of tanks or swimming pools. For use in water, the use of a fully resin coated power cable of H07RNF type is recommended.

For example, the Applicant has produced a lighting device 100 using PMMA to produce the optical component 4 and the coupling and closing blocks 15, which has allowed particularly optimum performances to be achieved. In greater detail, the lighting device obtained is suitable to be driven over up to 1000 kg/cm2, with an impact rating of IK10, with total absence of air inside and with IP68 protection rating, therefore suitable for continuous immersion in water, with a depth up to 3 m.

Excellent performances in terms of useful life have also been observed (over 100000 hours of operation), as the fact that the lighting device is waterproof prevents oxidation of the electrical contacts.

Production by coextrusion is particularly advantageous as it allows an optical component 4 to be obtained in one piece (monoblock) which is compact and strong without requiring a particularly complex production process.

Finally, the present invention is susceptible to numerous modifications and variants all falling within the scope of the appended claims, while the technical details can vary according to requirements.

1. A lighting device (100) comprising:
an electronic circuit board (1) bearing a plurality of sources of beams of light radiation (s1-sn);
a rigid optical component (4) facing said electronic circuit board to allow propagation of light radiation;
a housing (2) for the electronic circuit board and for the optical component provided with an opening (8) for the emission of light radiation;
wherein the optical component (4) is provided with a groove (13) for positioning of the electronic circuit board adapted to house the electronic circuit board (1) and a material transparent to radiation for fixing the electronic circuit board to said optical component (4).

2. The lighting device (100) according to claim 1, wherein the optical component (4) comprises a mixing layer of the beams of light radiation (11) and a propagating layer (12) such as to allow propagation of light radiation towards the mixing layer.

3. The lighting device (100) according to claim 2, wherein the propagating layer (12) is made of a material substantially transparent to light radiation and the mixing layer (11) is superimposed on the propagating layer (12) and is partially opaque.

4. The lighting device (100) according to claim 1, wherein said optical component is in a single piece.

5. The lighting device (100) according to claim 1, wherein at least one of said layers is made with a material belonging to the group composed of: thermoplastic polymer material, acrylic resin, poly-butyl-methacrylate, poly-butyl-n-acrylate, poly-ethyl-acrylate, poly-ethyl-methacrylate, poly-methylacrylate, poly-methyl-chloroacrylate, poly-methyl-methacrylate PMMA.

6. The lighting device (100) according to claim 1, wherein said mixing layer includes pigments adapted to opacify and to diffuse the beams of light radiation.

7. The lighting device (100) according to claim 1, wherein said optical component is a coextruded body.

8. The lighting device (100) according to claim 1, wherein said housing (2) includes means (3) for supporting the electronic circuit board and the optical component (4).

9. The lighting device (100) according to claim 1, wherein:
the supporting means comprise at least a supporting base (3);
the optical component extends from the opening until coming into contact with said at least one supporting base;
the electronic circuit board (1) is encapsulated in the transparent material such as, preferably, a protective epoxy resin and is placed on supporting edges (14a) produced in said groove (13).

10. The lighting device (100) according to claim 1, wherein said housing is a formwork (2) and said at least one supporting base defines a first region that houses the optical component (4) and a second region (9) that houses the power supply wires of said generating means.

11. The lighting device (100) according to claim 1, wherein said housing (2) is provided with at least one containing wall (7) comprising an inner seal (10) adapted to interfere with said optical component; the inner seal and the housing being obtainable by coextrusion.

12. The lighting device (100) according to claim 1, wherein the housing is made of metal or polycarbonate and said seal is made of polyurethane.

13. The lighting device (100) according to claim 1, wherein said sources are a plurality of LEDs (Light Emitting Diodes); said mixing layer allowing propagation and diffusion of light radiation so that it is substantially impossible for an observer to distinguish said sources.

14. The lighting device (100) according to claim 1, wherein the device is a light suitable to be built into masonry structures and has at least one of the properties in the group comprising: suitable to be walked over, suitable to be driven over, waterproof, suitably waterproof to be built into walls of tanks or swimming pools.

15. The lighting device (100) according to claim 1, further comprising at least one fixing unit (5) provided with coupling means (15, 23, 17) adapted to engage with the optical component and fixing means (15, 16, 22) adapted to engage with the housing.

16. A masonry structure comprising a wall having a cavity into which a lighting device according to claim 1 is installed.

17. A method for fabricating a lighting device (100) comprising:
supplying an electronic circuit board (1) bearing a plurality of sources of beams of light radiation (s1-sn);
supplying a rigid optical component (4) provided with a groove (13) for positioning of the electronic circuit board;
applying a fixing material transparent to radiation in said groove;
placing the electronic circuit board (1) in the groove provided with the transparent material fixing the electronic circuit board to the optical component (4);
arranging the rigid optical component associated with the electronic circuit board in a housing (2) equipped with an opening (8) for the emission of light radiation.
